(19) United States
(12) Patent Application Publication
(10) Pub. No.: US 2024/0299792 A1
(43) Pub. Date: Sep. 12, 2024

(54) FIRE SUPPRESSION SPRINKLER DEFROSTING ASSEMBLY AND SYSTEM

(71) Applicant: Harold Smith, The Colony, TX (US)

(72) Inventor: Harold Smith, The Colony, TX (US)

(21) Appl. No.: 18/118,800

(22) Filed: Mar. 8, 2023

(51) Int. Cl. A62C 35/68; C09K 5/20

(52) U.S. Cl. CPC A62C 35/68; C09K 5/20

(57) ABSTRACT

A fire suppression sprinkler defrosting assembly and system for providing antifreeze to an antifreeze loop includes a bucket containing a fluid comprising an antifreeze solution. A tubing is coupled to the bucket and is in fluid communication with an interior of the bucket, wherein the fluid is passable through the tubing. A valve is coupled to the tubing and is positionable from a closed position to an open position, wherein the valve permits flow of the fluid through the tubing. A pump is coupled to the tubing and is in fluid communication with the interior of the bucket, wherein the pump is actuated to pump the fluid out from the bucket through the tubing when the valve is positioned to the open position. The pump is in fluid communication with an antifreeze loop, wherein the antifreeze solution is provided to the antifreeze loop when the pump is actuated.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to deicing system and more particularly pertains to a new deicing system for providing antifreeze to an antifreeze loop.

### (2) Description of Related Art Including Information Disclosed Under 37 CFR 1.97 and 1.98

The prior art relates to deicing systems and includes a variety of deicing systems utilizing antifreeze solution to deice a surface. Known prior art does not include an assembly being configured for channeling in antifreeze solution into an antifreeze loop to dispense antifreeze solution from a fire suppression sprinkler.

### BRIEF SUMMARY OF THE INVENTION

An embodiment of the disclosure meets the needs presented above by generally comprising a bucket containing a fluid comprising an antifreeze solution. A tubing is coupled to the bucket and is in fluid communication with an interior of the bucket, wherein the fluid is passable through the tubing. A valve is coupled to the tubing. The valve is positionable from a closed position wherein the valve prevents flow of the fluid through the tubing to an open position wherein the valve permits flow of the fluid through the tubing. A pump is coupled to the tubing and is in fluid communication with the interior of the bucket, wherein the pump is actuated to pump the fluid out from the bucket through the tubing when the valve is positioned to the open position. The pump is configured for being in fluid communication with an antifreeze loop, the antifreeze loop is configured for providing the antifreeze solution to a fire suppression sprinkler to deice areas proximate to the fire suppression sprinkler, wherein the antifreeze solution is provided to the antifreeze loop when the pump is actuated.

Another embodiment of the disclosure includes a system comprising an antifreeze loop is configured for providing the antifreeze solution to a fire suppression sprinkler to deice areas proximate to the fire suppression sprinkler. A bucket contains the antifreeze solution. A tubing is coupled to the bucket and is in fluid communication with an interior of the bucket, wherein the antifreeze solution is passable through the tubing. A valve is coupled to the tubing. The valve is positionable from a closed position wherein the valve prevents flow of the antifreeze solution through the tubing to an open position wherein the valve permits flow of the antifreeze solution through the tubing. A pump is coupled to the tubing and is in fluid communication with the interior of the bucket, wherein the pump is actuated to pump the antifreeze solution out from the bucket through the tubing when the valve is positioned to the open position. The pump is in fluid communication the antifreeze loop, wherein the antifreeze solution is provided to the antifreeze loop when the pump is actuated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a fire suppression sprinkler defrosting assembly and system according to an embodiment of the disclosure.

FIG. 2 is a top isometric view of an embodiment of the disclosure.

FIG. 3 is a top view of an embodiment of the disclosure.

FIG. 4 is a cross-sectional view of an embodiment of the disclosure taken along Line 4-4 of FIG. 3.

FIG. 5 is a cross-sectional view of an embodiment of the disclosure taken along Line 5-5 of FIG. 3.

FIG. 6 is a cross-sectional view of an embodiment of the disclosure taken along Line 6-6 of FIG. 3.

FIG. 7 is an in-use view of an embodiment of the disclosure.

FIG. 8 is an in-use view of an embodiment of the disclosure.

### DETAILED DESCRIPTION OF THE INVENTION

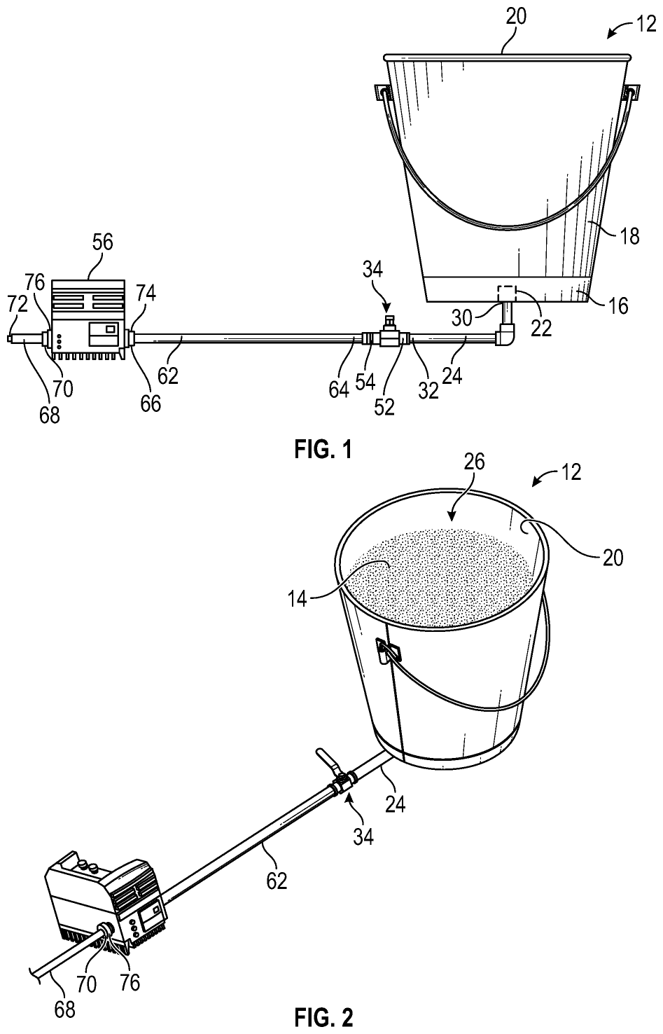

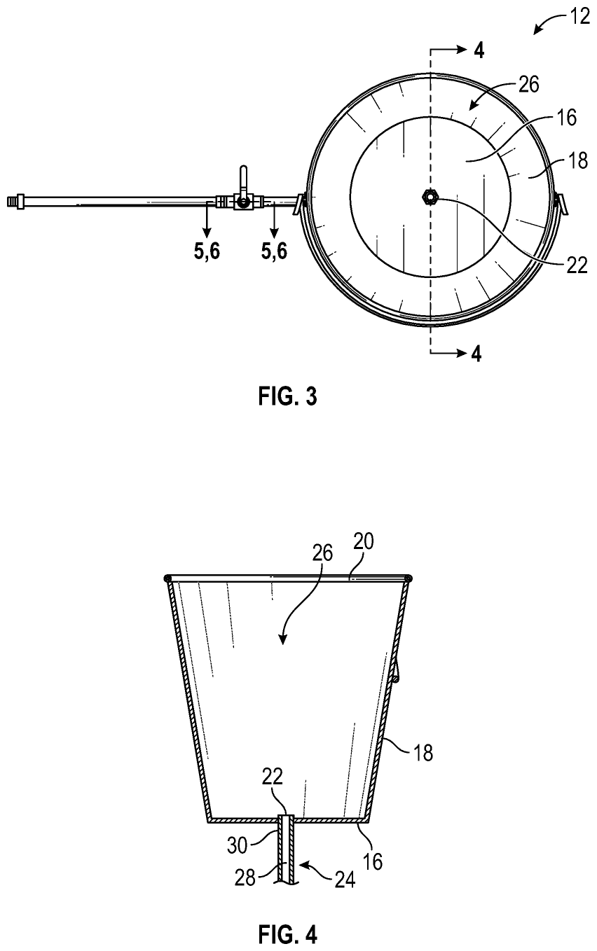

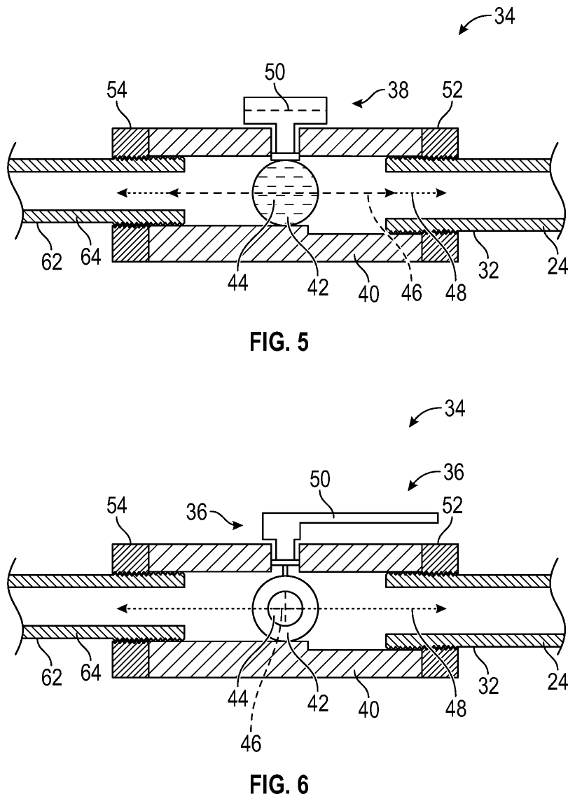

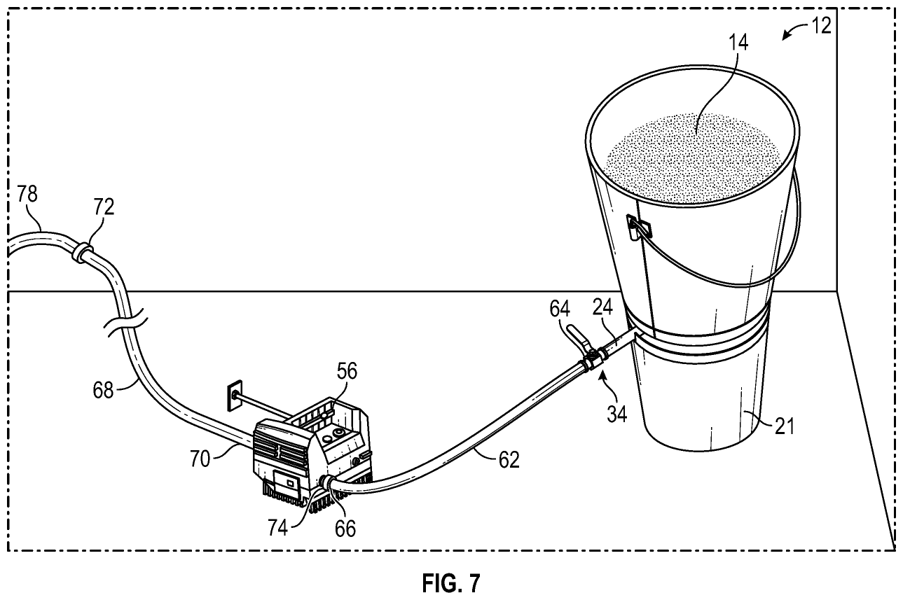

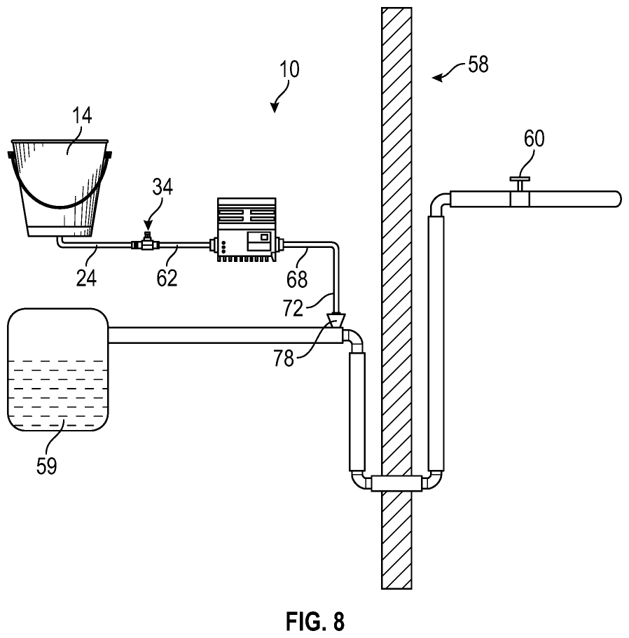

With reference now to the drawings, and in particular to FIGS. 1 through 8 thereof, a new deicing system embodying the principles and concepts of an embodiment of the disclosure and generally designated by the reference numeral 10 will be described.

As best illustrated in FIGS. 1 through 8, the fire suppression sprinkler defrosting assembly and system 10 generally comprises a bucket 12 containing a fluid 14 comprising an antifreeze solution. The bucket 12 typically includes a base wall 16 and a perimeter wall 18 coupled to and extending upwardly from the base wall 16. A top edge of the perimeter wall 18 defines an access 20 into the bucket 12. An outlet 22 extends through the base wall 16 of the bucket 12. The bucket 12 may be mounted upon a fixed structure 21 to facilitate retaining the bucket 12 in a fixed position, wherein the fixed structure 21 inhibits the bucket 12 from tilting over and spilling the fluid 14 from the access 20 of the bucket 12. A tubing 24 is coupled to the bucket 12 and is in fluid communication with an interior 26 of the bucket 12, wherein the fluid 14 is passable through the tubing 24. The tubing 24 normally encloses a hollow space 28 including a first end 30 and a second end 32. The first 30 and second 32 ends are open, and the first end 30 of the tubing 24 may be coupled to the outlet 22 of the base wall 16.

A valve 34 is coupled to the tubing 24 and is positionable from a closed position 36 wherein the valve 34 prevents flow of the fluid 14 through the tubing 24 to an open position 38 wherein the valve 34 permits flow of the fluid 14 through the tubing 24. The valve 34 may comprise a ball valve including a channel 40 having a ball 42 positioned within the channel 40 and the ball 42 normally has an aperture 44 extending through a front center of the ball 42. A horizontal axis 46 of the aperture 44 of the ball 42 is co-axial with a lateral axis 48 of the channel 40 in the open position 38. The horizontal axis 46 of the aperture 44 of the ball 42 is not co-axial with the lateral axis 48 of the channel 40 in the closed position 36. A lever 50 is mechanically coupled to the ball 42 and is actuated to rotatably position the ball 42 from the open position 38 to the closed position 36. The lever 50 normally comprises a handle pivotally coupled to a top of the valve 34. The channel 40 has a first opening 52 and a second opening 54, and the first opening 52 may be coupled to the second end 32 of the tubing 24.

A pump 56 is coupled to the tubing 24 and is in fluid communication with the interior 26 of the bucket 12, wherein the pump 56 is actuated to pump the fluid 14 out from the bucket 12 through the tubing 24 when the valve 34 is positioned to the open position 38. The pump 56 is configured for being in fluid communication with an antifreeze loop 58. The antifreeze loop 58 is configured for providing the antifreeze solution to a fire suppression sprinkler 60 to deice areas proximate to the fire suppression sprinkler 60, wherein the antifreeze solution is provided to the antifreeze loop 58 when the pump 56 is actuated. The antifreeze solution may be added to water provided by a water tank 59 to the fire suppression sprinkler 60, wherein the antifreeze solution may lower the freezing point of water emitted from the fire suppression sprinkler 60. The pump 56 is configured to remove air bubbles from the fluid 14 when pumping the fluid 14 from the interior 26 of the bucket 12 through the tubing 24, wherein the pump 56 prevents cavitation within the fluid 14.

The pump 56 may have a first piping 62 including a distal end 64 and a proximal end 66 relative to the pump 56. The distal 64 and proximal 66 ends are open, and the distal end 64 may be coupled to the second opening 54 of the channel 40 of the valve 34. The proximal end 66 may be coupled to an inlet opening 74 of the pump 56. The pump 56 may have a second piping 68 including a primary end 70 and a secondary end 72. The primary 70 and secondary 72 ends are open, and the primary end 70 may be coupled to an output opening 76 of the pump 56. The secondary end 72 may be configured for coupling to a receiving port 78 of the antifreeze loop 58.

In use, the interior 26 of the bucket 12 receives fluid 14 comprising the antifreeze solution. The first piping 62 of the pump 56 is coupled to the tubing 24 of the bucket 12 and the second piping 68 of the pump 56 is coupled to the antifreeze loop 58 of the fire suppression sprinkler 60. The valve 34 is positioned into the open position 38 and the pump 56 is actuated to pump the fluid 14 out from the bucket 12 through the tubing 24 into the antifreeze loop 58, wherein the antifreeze solution is provided to the antifreeze loop 58.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fire suppression sprinkler defrosting assembly comprising:
a bucket containing a fluid, said fluid comprising an antifreeze solution;
a tubing being coupled to said bucket and being in fluid communication with an interior of said bucket, wherein said fluid is passable through said tubing;
a valve being coupled to said tubing, said valve being positionable from a closed position wherein said valve prevents flow of the fluid through the tubing to an open position wherein said valve permits flow of the fluid through the tubing; and
a pump being coupled to said tubing and being in fluid communication with the interior of the bucket, wherein the pump is actuated to pump said fluid out from said bucket through said tubing when said valve is positioned to said open position, said pump being configured for being in fluid communication with an antifreeze loop, said antifreeze loop being configured for dispensing an antifreeze solution from a fire suppression sprinkler to deice areas proximate to the fire suppression sprinkler, wherein said antifreeze solution is provided to said antifreeze loop when said pump is actuated.

2. The fire suppression sprinkler defrosting assembly of claim 1, wherein said bucket includes a base wall and a perimeter wall coupled to and extending upwardly from said base wall, a top edge of said perimeter wall defining an access into said bucket, an outlet extending through said base wall.

3. The fire suppression sprinkler defrosting assembly of claim 2, wherein said tubing encloses a hollow space including a first end and a second end, said first and second ends being open, said first end of said tubing being coupled to said outlet of said base wall.

4. The fire suppression sprinkler defrosting assembly of claim 3, wherein said valve comprises a ball valve including a channel having a ball positioned within said channel, said ball having an aperture extending through a front center of said ball, a horizontal axis of said aperture of said ball is co-axial with a lateral axis of said channel in said open position of said valve, said horizontal axis of said aperture of said ball is not co-axial with said lateral axis of said channel in said closed position, a lever being mechanically coupled to said ball and being actuated to rotatably position said ball from said open position to said closed position, said channel having a first opening and a second opening, said first opening being coupled to said second end of said tubing

5. The fire suppression sprinkler defrosting assembly of claim 4, wherein said pump has a first piping including a distal end and a proximal end relative to said pump, said distal and proximal ends being open, said distal end being coupled to said second opening of said channel of said valve, said proximal end being coupled to an inlet opening of said pump, said pump having a second piping including a primary end and a secondary end, said primary and secondary ends being open, said primary end being coupled to an output opening of said pump, said secondary end being configured for coupling to a receiving port of the antifreeze loop.

6. A fire suppression sprinkler defrosting kit comprising:
a bucket containing a fluid, said fluid comprising an antifreeze solution, said bucket including a base wall and a perimeter wall coupled to and extending upwardly from said base wall, a top edge of said perimeter wall defining an access into said bucket, an outlet extending through said base wall;
a tubing being coupled to said bucket and being in fluid communication with an interior of said bucket, wherein said fluid is passable through said tubing, said tubing enclosing a hollow space and including a first end and a second end, said first and second ends being open, said first end of said tubing being coupled to said outlet of said base wall;
a valve being coupled to said tubing, said valve being positionable from a closed position wherein said valve prevents flow of the fluid through the tubing to an open position wherein said valve permits flow of the fluid through the tubing, said valve comprising a ball valve including a channel having a ball positioned within said channel, said ball having an aperture extending through a front center of said ball, a horizontal axis of said aperture of said ball is co-axial with a lateral axis of said channel in said open position of said valve, said horizontal axis of said aperture of said ball is not co-axial with said lateral axis of said channel in said closed position, a lever being mechanically coupled to said ball and being actuated to rotatably position said ball from said open position to said closed position, said channel having a first opening and a second opening, said first opening being coupled to said second end of said tubing; and
a pump being coupled to said tubing and being in fluid communication with the interior of the bucket, wherein the pump is actuated to pump said fluid out from said bucket through said tubing when said valve is positioned to said open position, said pump being configured for being in fluid communication with an antifreeze loop, said antifreeze loop being configured for providing said antifreeze solution to a fire suppression sprinkler to deice areas proximate to the fire suppression sprinkler, wherein said antifreeze solution is provided to said antifreeze loop when said pump is actuated, said pump having a first piping including a distal end and a proximal end relative to said pump, said distal and proximal ends being open, said distal end being coupled to said second opening of said channel of said valve, said proximal end being coupled to an inlet opening of said pump, said pump having a second piping including a primary end and a secondary end, said primary and secondary ends being open, said primary end being coupled to an output opening of said pump, said secondary end being configured for coupling to a receiving port of the antifreeze loop.

7. A fire suppression sprinkler defrosting system comprising:
an antifreeze loop being configured for providing an antifreeze solution to a fire suppression sprinkler to deice areas proximate to the fire suppression sprinkler;
a bucket containing the antifreeze solution;
a tubing being coupled to said bucket and being in fluid communication with an interior of said bucket, wherein the antifreeze solution is passable through said tubing;
a valve being coupled to said tubing, said valve being positionable from a closed position wherein said valve prevents flow of the antifreeze solution through the tubing to an open position wherein said valve permits flow of the antifreeze solution through the tubing; and
a pump being coupled to said tubing and being in fluid communication with the interior of the bucket, wherein the pump is actuated to pump the antifreeze solution out from said bucket through said tubing when said valve is positioned to said open position, said pump being in fluid communication the antifreeze loop, wherein the antifreeze solution is provided to the antifreeze loop when the pump is actuated.

8. The fire suppression sprinkler defrosting system of claim 7, wherein said bucket includes a base wall and a perimeter wall coupled to and extending upwardly from said base wall, a top edge of said perimeter wall defining an access into said bucket, an outlet extending through said base wall.

9. The fire suppression sprinkler defrosting system of claim 8, wherein said tubing encloses a hollow space including a first end and a second end, said first and second ends being open, said first end of said tubing being coupled to said outlet of said base wall.

10. The fire suppression sprinkler defrosting system of claim 9, wherein said valve comprises a ball valve including a channel having a ball positioned within said channel, said ball having an aperture extending through a front center of said ball, a horizontal axis of said aperture of said ball is co-axial with a lateral axis of said channel in said open position of said valve, said horizontal axis of said aperture of said ball is not co-axial with said lateral axis of said channel in said closed position, a lever being mechanically coupled to said ball and being actuated to rotatably position said ball from said open position to said closed position, said channel having a first opening and a second opening, said first opening being coupled to said second end of said tubing.

11. The fire suppression sprinkler defrosting system of claim 10, wherein said pump has a first piping including a distal end and a proximal end relative to said pump, said distal and proximal ends being open, said distal end being coupled to said second opening of said channel of said valve, said proximal end being coupled to an inlet opening of said pump, said pump having a second piping including a primary end and a secondary end, said primary and secondary ends being open, said primary end being coupled to an output opening of said pump, said secondary end being coupled to a receiving port of the antifreeze loop.

12. The fire suppression sprinkler defrosting system of claim 7, wherein the fire suppression sprinkler defrosting system comprises:
an antifreeze loop being configured for providing an antifreeze solution to a fire suppression sprinkler to deice areas proximate to the fire suppression sprinkler;
a bucket containing the antifreeze solution, said bucket including a base wall and a perimeter wall coupled to and extending upwardly from said base wall, a top edge of said perimeter wall defining an access into said bucket, an outlet extending through said base wall;
a tubing being coupled to said bucket and being in fluid communication with an interior of said bucket, wherein the antifreeze solution is passable through said tubing, said tubing enclosing a hollow space and including a first end and a second end, said first and second ends being open, said first end of said tubing being coupled to said outlet of said base wall;
a valve being coupled to said tubing, said valve being positionable from a closed position wherein said valve prevents flow of the antifreeze solution through the tubing to an open position wherein said valve permits flow of the antifreeze solution through the tubing, said valve comprising a ball valve including a channel having a ball positioned within said channel, said ball having an aperture extending through a front center of said ball, a horizontal axis of said aperture of said ball is co-axial with a lateral axis of said channel in said open position of said valve, said horizontal axis of said aperture of said ball is not co-axial with said lateral axis of said channel in said closed position, a lever being mechanically coupled to said ball and being actuated to rotatably position said ball from said open position to said closed position, said channel having a first opening and a second opening, said first opening being coupled to said second end of said tubing; and
a pump being coupled to said tubing and being in fluid communication with the interior of the bucket, wherein the pump is actuated to pump the antifreeze solution out from said bucket through said tubing when said valve is positioned to said open position, said pump being in fluid communication with the antifreeze loop, wherein the antifreeze solution is provided to the antifreeze loop when the pump is actuated, said pump having a first piping including a distal end and a proximal end relative to said pump, said distal and proximal ends being open, said distal end being coupled to said second opening of said channel of said valve, said proximal end being coupled to an inlet opening of said pump, said pump having a second piping including a primary end and a secondary end, said primary and secondary ends being open, said primary end being coupled to an output opening of said pump, said secondary end being coupled to a receiving port of the antifreeze loop.
